(19) United States
(12) Patent Application Publication
(10) Pub. No.: US 2015/0125153 A1
(43) Pub. Date: May 7, 2015

(54) METHOD FOR MEASURING WAVELENGTH CHANNEL TUNING TIME OF TUNABLE DEVICE IN OPTICAL NETWORK, AND SYSTEM THEREOF

(71) Applicant: ELECTRONICS AND TELECOMMUNICATIONS RESEARCH INSTITUTE, Daejeon-si (KR)

(72) Inventors: Jie Hyun LEE, Daejeon-si (KR); Han Hyub LEE, Daejeon-si (KR); Eun Gu LEE, Daejeon-si (KR); Kyeong Hwan DOO, Daejeon-si (KR)

(21) Appl. No.: 14/532,369

(22) Filed: Nov. 4, 2014

(30) Foreign Application Priority Data
Nov. 4, 2013 (KR) 10-2013-0133226
Mar. 7, 2014 (KR) 10-2014-0027409
Jul. 11, 2014 (KR) 10-2014-0087806
Oct. 13, 2014 (KR) 10-2014-0137895

(51) Int. Cl. H04B 10/572; H04J 14/02

(52) U.S. Cl. CPC H04B 10/572; H04J 14/02
USPC 398/79; 398/182

(57) ABSTRACT

A method for measuring a wavelength channel tuning time by using an optical filter that converts a change of an output wavelength of a tunable device into an optical intensity change, and a system thereof. The system for measuring a wavelength channel tuning time includes: an optical filter set configured to convert a wavelength change of an optical tunable device into an optical output intensity change; at least one or more optical electric converters configured to convert the optical output intensity change output by the optical filter set into an electric signal; and a controller configured to generate a wavelength change command applied to the tunable device, so as to calculate a wavelength channel tuning time of the tunable device by using the wavelength change command and the electric signal output by the optical electric converter.

### CROSS-REFERENCE TO RELATED APPLICATION(S)

This application claims priority from Korean Patent Application Nos. 10-2013-0133226, filed on Nov. 4, 2013, 10-2014-0027409, filed on Mar. 7, 2014, 10-2014-0087806, filed on Jul. 11, 2014, and 10-2014-0137895, filed on Oct. 13, 2014, in the Korean Intellectual Property Office, the entire disclosures of which are incorporated herein by references for all purposes.

### BACKGROUND

1. Field

The following description generally relates to a method for measuring a wavelength channel tuning time of a tunable device used in an optical network, and a system thereof, and more particularly to a method for measuring a wavelength channel tuning time by using an optical filter that converts an output wavelength change to an optical intensity change, and a system thereof.

2. Description of the Related Art

With the development of optical communication technology and a sharp increase in the demand for Internet services, fundamental research on an optical access network has been conducted since the early 2000s. As a result of such research, a broadband convergence network, such as Fiber To The Home (FTTH), or Fiber To The Office (FTTO), which directly connects an office or a central office (CO) to subscribers, has been widely used.

Further, recent research is being actively conducted on next generation ultrahigh-speed, large-scale optical access network to handle an enormous increase in traffic caused by widespread distribution of mobile Internet protocol (IP) terminals, commercialization of IP television (TV) services, and widespread multimedia broadcast/streaming services through the Internet.

As a method for efficiently providing services to many subscribers by using limited network resources, a Time Division Multiplexing (TDM) technique or a Wavelength Division Multiplexing (WDM) technique is applied to an optical access network technology. Further, research has been recently conducted on an optical access network using a hybrid technique in which both the TDM technique and the WDM technique are applied.

A Time and Wavelength Division Multiplexing (TWDM) technique using a hybrid technique, in which both the TDM method and the WDM method are applied, may satisfy a demand for expanding a network bandwidth, and may expand communication capacity and a number of subscribers, while providing ultrahigh-speed communication services to many is subscribers. Accordingly, much research is being conducted on the TWDM optical access network as a next generation optical access network following 10 Gbps passive optical access network technology.

In a multi-wavelength passive optical network (PON), such as WDM PON or hybrid-PON, a WDM optical transceiver of multiple wavelengths is required. Such WDN transceiver may be implemented in various manners, among which in a case where a wavelength tunable optical transceiver is used, a transceiver is not needed to be manufactured for every wavelength, thereby enhancing efficiency in equipment management, and enabling efficient use of wavelength resources.

However, in a case where a wavelength tunable WDM transceiver is used in an optical network unit (ONU), a WDM wavelength of the WDM transceiver, which may be output or received, is required to be set. A wavelength for initial use of a wavelength tunable ONU may be set by a subscriber when installing an ONU that includes a WDM transceiver, or an initial wavelength of a wavelength tunable ONU may be set by using a protocol between an optical line terminal (OLT) and an ONU.

The setting of a wavelength of a wavelength tunable ONU is performed in a process of initialization or activation. Further, in a case where a wavelength used by a wavelength tunable ONU is required to be newly set, the wavelength setting is performed through a Physical Layer Operations, Administration and Maintenance (PLOAM) message. More specifically, in a case where an OLT port, while being in communication, is placed into a sleep mode for power saving, in a case where a problem occurs in the OLT-port, or in a case where a specific OLT-port receives an excessively heavy traffic, a wavelength tunable ONU, which is in communication with the OLT-port, should be reallocated to other OLT-port, such that a new wavelength is required to be reset. Further, resetting of a wavelength is performed in a case where wavelength resources are dynamically allocated for flexible and efficient use of wavelength resources.

That is, after a PLOAM message related to the wavelength resetting is transmitted to a wavelength tunable ONU, a wavelength to be used by the wavelength tunable ONU is reset, thereby enabling communications with a newly allocated OLT-port. As time taken for resetting or changing a wavelength used by the wavelength tunable ONU varies depending on specific technologies of the wavelength tunable ONU, a timer setting and the like may be facilitated in terms of system management by separating time required for the wavelength tunable ONU to change wavelengths.

In other words, by checking whether a signal is transmitted from the wavelength tunable ONU after a timer setting, the OLT may check whether the wavelength tunable ONU is properly operated. Further, after a timer setting, the wavelength tunable ONU may check whether an output wavelength is changed to a reset wavelength channel, and transmits an upstream signal to a newly set OLT-port.

In a system where an optical distribution node (ODN) includes an optical power splitter, instead of a wavelength distributor, if an optical transceiver is turned on when a wavelength resetting of a wavelength tunable ONU is not complete, an upstream signal is transmitted to other wavelength channel, thereby having an adverse effect on other OLT-port.

For this reason, there is a need to measure a time required for changing a wavelength according to a wavelength resetting message of a wavelength tunable ONU, and to classify the wavelength tunable ONU.

That is, as the wavelength tunable ONU reports its wavelength tunable class to the OLT, the OLT may be aware of whether the wavelength tunable ONU may perform specific requirements (initialization, protection, load balancing, wavelength dynamic allocation) related to wavelength resetting. Further, a system (or network) operator may establish a system by selectively receiving a wavelength tunable ONU of a specific class when establishing a system.

### SUMMARY

Disclosed is a method for measuring a wavelength channel tuning time of a tunable device used in an optical communication network, and a system thereof.

Features and aspects of the present disclosure are not limited to the above-described purposes, and other features and aspects not described herein may be apparent from the following detailed description.

An apparatus for separating classes of optical tunable devices by measuring a wavelength channel tuning time may have different configurations depending on whether a tunable device is a transmitter or a receiver. In a case where a tunable device is a transmitter, the apparatus for separating classes of optical tunable devices include: at least one or more optical tunable devices, of which a wavelength channel tuning time is to be measured; an optical filter set configured to convert a wavelength change into an optical output intensity change; at least one or more optical electric converters configured to convert an output of the tunable device into an electric signal; and a waveform monitor configured to monitor a waveform of the signal converted into the electric signal.

The apparatus may further include a controller to transmit a wavelength channel change command to the optical tunable device.

The apparatus may further have a function of constant temperature. For example, the optical tunable device may be disposed in a chamber of constant temperature. As the optical tunable device has a function of constant temperature, measurement may always be performed in constant temperature, thereby enhancing reliability.

The controller may be a pulse generator that applies a direct current or a direct voltage, or a device that applies a step signal to apply a direct current or a direct voltage, so as to change an output wavelength of the optical tunable devices, or a device that transmits an output wavelength change command through RS232, I2C, dual port RAM, GPIB, or the like.

The wavelength channel tuning time of the optical tunable device is duration from when a wavelength change command is given by the controller to when a waveform of a signal begins to be stabilized in a desired wavelength, i.e., a target wavelength-division multiplexing (WDM) channel. For example, in a case where a wavelength is measured with optical intensity by photoelectrically converting a wavelength change, a wavelength channel tuning time may be duration from when a wavelength change command is given by the controller to when optical intensity measurable in the target WDM channel gradually increases and begins to be stabilized (wavelength channel tuning time: maximum time taken for the optical power from the tunable device to begin to decrease in the original wavelength channel (after a wavelength change control signal), to the time when the optical power form the tunable device appears and remains stable within the desired wavelength channel).

In FIG. 9D, the initial power and the target power may be identical, as an insertion loss for wavelength division multiplexing channel of an optical filter set used in a measuring setup is normalized. Otherwise, the initial power and the target power may not be identical. If they are not identical, measurement may be performed as illustrated in FIG. 9B. X % and Y % in FIGS. 9B, 9D, and 9F may be identical. X and Y values vary depending on wavelength division multiplexing channel width and a transmission waveform of a filter used in the optical filter set.

The wavelength channel tuning time may be represented by a time indicator that may be measured by the waveform monitor, as in Equation 1: Tₚ (or Tₗ)+Tₜᵣ+T_{c}, in which the (Tₚ or Tₗ) is a processing time or latency time for an output wavelength of the tunable device to be changed, i.e. duration from when a wavelength change command is given to a tunable device to when optical intensity measurable in a previous WDM channel (prior to the wavelength change command) begins to change by X %, T_{c} is a time for an optical intensity change, which is measurable in the target (WDM) channel, to begin to be stabilized within Y % of a final optical intensity, and Tₜᵣ is a time when an output wavelength of a tunable device moves, i.e., a time between Tₚ and T_{c}.

The optical electric converter used in an apparatus for measuring a tuning time of a tunable device is required to have a bandwidth corresponding to 10×(1/Tₜᵣ)Hz from DC, when assuming that Tₜᵣ is a time when a wavelength moves between channels during a wavelength channel tuning time of an optical tunable device to be measured.

The waveform monitor may immediately capture a signal of multiple channels, and may divide two channels at the same time on one screen. The waveform monitor may use, as a trigger signal, a waveform of a signal converted into an electric signal and a waveform of a signal applied by a controller as a wavelength channel change command, and may display the signals on a waveform monitor, thereby facilitating analysis of a wavelength channel tuning time of a tunable device.

Further, for measurement, a voltage range and a time axis range desired by a user may be selected at random. A user may be notified whether a signal is in a desired range or not. Further, a desired measurement environment may be stored in a non-volatile memory, and may be used when necessary for measurement, such that there is no need to manually set the environment. By comparing an electric signal for power change of a wavelength channel according to elapsed time to a mask for measuring a wavelength tuning time that is predetermined according to classes, classes of tunable devices may be separated.

Moreover, in an apparatus for separating classes of tunable devices by measuring a wavelength channel tuning time, the tunable devices may be a tunable device necessary for an optical line terminal (OLT) or in an optical network unit (ONU) of a passive optical communication network system.

In the apparatus, the electric signal may be a value for a change of power before and after a wavelength channel, and a monitored signal may be a value that corresponds to the power change, and may enable a tuning time to be measured. The value that corresponds to the power change may be normalized.

In a case where a tunable device is a receiver, the apparatus may include one or more reference transmitters configured to transmit an optical signal of a specific wavelength to the optical tunable devices; at least one or more optical electric converters configured to convert the optical signal transmitted by the one or more reference transmitters and received by the optical tunable devices; and a waveform monitor configured to monitor a waveform of the optical signal converted into the electric signal, in which classes of the optical tunable devices are determined by comparing a result monitored by the waveform monitor to a predetermined wavelength tuning mask. Further, the tunable receiver may further include a controller configured to transmit a wavelength channel change command to the optical tunable devices. The above details regarding the tunable transmitter may be applied to a tunable transceiver, such that detailed description of the tunable transceiver will be omitted.

In addition, in the apparatus for separating classes of tunable devices by measuring a wavelength channel tuning time, the classes may be separated into class 1 (short: <10), class 2 (medium: 10 to 25 ms), and class 3 (medium 25 ms to 1 s).

Further, in the apparatus, the classes may be used to classify an ONU that is operated regardless of wavelengths, or a function to reduce maintenance costs, PON protection, load balancing, a wavelength reallocation function that includes variable wavelength channel allocation, or a tuning time required for performing combinations thereof.

In the apparatus, the tunable device, of which a tuning time is to be measured, may include one of a tunable transmitter, a tunable receiver, or a tunable optical filter.

In the apparatus, in a case where the tunable device is a tunable transmitter, at least one or more optical filters that are further included for a test setup at an output end of the tunable device may include at least one or more attenuators, or a combination thereof.

In the apparatus, in a case where the tunable device is a tunable transmitter, at least one or more optical filters that are further included for a test setup at an output end of the tunable device may be selectively tested by connecting two AWGs to correspond to each other.

In the apparatus, in a case where the tunable device is a tunable transmitter, at least one or more optical filters that are further included for a test setup at an output end of the tunable device may be at least one optical etalon filters.

Further, in the apparatus, in a case where the tunable device is a tunable receiver, the tunable device may include at least one or more reference optical transmitters that are further included for a test setup at an input end of the tunable device, at least one or more attenuators, or a combination thereof.

In the apparatus, in a case where the tunable device is a tunable optical filter, the tunable device may include at least one or more reference optical transmitters that are further included for a test setup at an input end of the tunable device, at least one or more attenuators, or a combination thereof.

Moreover, the apparatus for measuring a wavelength channel tuning time may include: at least one or more reference devices; at least one or more optical electric converters configured to convert an output of a tunable device into an electric signal; and a waveform monitor configured to monitor the signal converted into the electric signal, in which by the monitoring, the electric signal for a power change of a wavelength channel according to elapsed time is compared to a wavelength tuning mask pattern predetermined according to classes, so as to separate classes of the tunable device.

### BRIEF DESCRIPTION OF THE DRAWINGS

FIGS. 1 (A) and 1 (B) are block diagrams illustrating an example (A) and another example (B) of a multiple wavelength passive optical communication network system that includes wavelength tunable light sources.

FIG. 2 is a flowchart to explain a wavelength channel tuning time in a wavelength channel tuning process.

FIG. 3 is a diagram illustrating a tuning mask is applied to an optical intensity changed according to a change in a measured wavelength, according to an exemplary embodiment.

FIGS. 4 (A) to 4(E) are diagrams illustrating an example of a test setup used for measuring a wavelength channel tuning time of a wavelength tunable optical transceiver according to an exemplary embodiment.

FIG. 5 is a block diagram illustrating an example of a test setup used for measuring a wavelength channel tuning time of a wavelength tunable optical filter according to an exemplary embodiment.

FIG. 6 is a block diagram illustrating an example of a system for measuring a wavelength channel tuning time of a tunable device according to another exemplary embodiment.

FIG. 7 is a diagram illustrating a measuring result of optical intensity changed according to wavelength changes, according to an exemplary embodiment.

FIG. 8 is a diagram illustrating another measuring result of optical intensity changed according to wavelength changes, according to an exemplary embodiment.

FIG. 9A is a block diagram illustrating a measuring setup in a case of using a control method of changing an output wavelength of a tunable device through a direct voltage or a direct current by using a pulse generator.

FIG. 9B is a graph illustrating information for measuring a wavelength channel tuning time of a specific output wavelength from a starting point of a control signal in a measuring setup.

FIG. 9C is a block diagram of a measuring setup in a case of using a control method of changing an output wavelength of a tunable device by using a command through RS232, GPIB, I2C, and the like.

FIG. 9D is a graph illustrating information for measuring a wavelength channel tuning time of a specific output wavelength from a starting point of a control signal in a measuring setup in FIG. 9C.

FIG. 9E is a block diagram illustrating a measuring setup in a case of using a control method of changing an output wavelength of a tunable device by using a step signal that may change voltage or current.

FIG. 9F is a graph illustrating information for measuring a wavelength channel tuning time of a specific output wavelength from a starting point of a control signal in a measuring setup in FIG. 9E.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

An apparatus or a method for measuring a wavelength channel tuning time according to an exemplary embodiment, which will be described below, may be applied to measurement of a wavelength channel tuning time of a wavelength tunable device used in a multiple wavelength passive optical communication network. A wavelength tunable device may be any one among wavelength tunable optical sources, a wavelength tunable optical transmitter, a wavelength tunable optical receiver, and a wavelength tunable filter.

The wavelength tunable optical sources or the wavelength tunable optical transmitter refers to optical sources or an optical transmitter that may selectively generate lights of different wavelengths. The wavelength tunable optical receiver is an optical receiver that may selectively receive lights of different wavelengths, and the wavelength tunable filter is an optical filter that may selectively transmit lights of different wavelengths.

The wavelength tunable device may be used for wavelength division multiplexed passive optical network (WDM-PON), and a hybrid PON with a TDM method and a WDM method combined, e.g. TWDM or OFDM PON system. In the present disclosure, the PON system using a WDM method will be referred to as a multi wavelength PON system.

In the PON system, a wavelength channel tuning time refers to a time from a time when a wavelength tunable device receives a command to change an operating wavelength originally used by a wavelength tunable device to a time when the wavelength tunable device stably tunes to a newly allocated wavelength channel.

In the MW PON system, an operating wavelength of a wavelength tunable device may be required to be changed in several cases. For example, in a case where an optical network unit (ONU) 30 of the MW PON system includes one or more wavelength tunable device, in a case of activating these devices, or in a case of tuning to a newly allocated wavelength channel, an operating wavelength of the wavelength tunable device may be required to be changed.

In another example, in the MW PON system that includes a plurality of optical line terminals (OLTs), an operation of some of the OLTs may be stopped for operating in a power saving mode, and in a case where ONUS 30 connected to the OLTs are tuned to a wavelength channel to be communicable with other operating OLTs, an operating wavelength of a wavelength tunable device may be required to be changed. In this case, an operating wavelength of the wavelength tunable device may be required to be changed.

In still another example, in the MW PON system, in a case where wavelength resources are needed to be dynamically allocated, or in a case where a performance, such as an operating wavelength of a wavelength tunable device being drifted or being well maintained within a predetermined grid, is required to be checked, an operating wavelength of a wavelength tunable device is required to be changed.

Wavelength changing in the MW PON system may be subdivided into the following processes. For example, the ONU 30 having a wavelength tuning function receives a wavelength change command from an OLT by using a PLOAM or OMCI channel; a wavelength is changed; and upon completion of the changing process, a predetermined subsequent procedure is performed.

Wavelength tuning of a wavelength tunable device may vary depending on types or configurations of the MW PON system.

For example, a wavelength of the ONU 30 (more specifically a wavelength tunable device included in the ONU 30), which is newly activated in an activation process, may be required to be tuned to a certain allocated wavelength.

Further, even after the ONU 30 is activated, if a previously allocated wavelength is changed to other wavelength, a wavelength of the ONU 30 may be required to be tuned to a newly allocated wavelength. Changing of wavelengths is performed by a network system manager to manage wavelength resources or to improve performance by load balancing of a network system, but wavelength changing are not limited thereto.

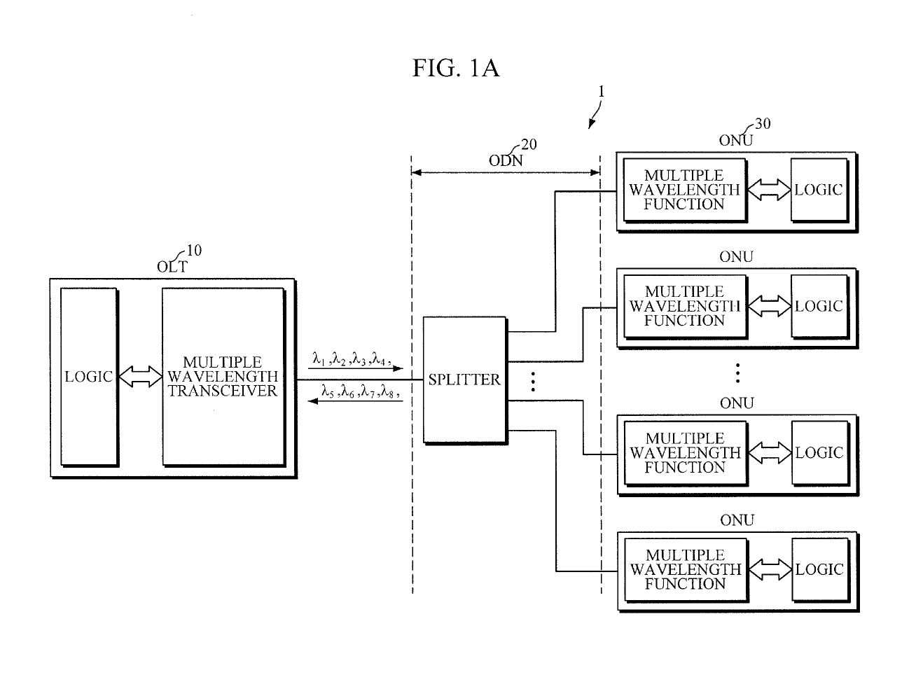

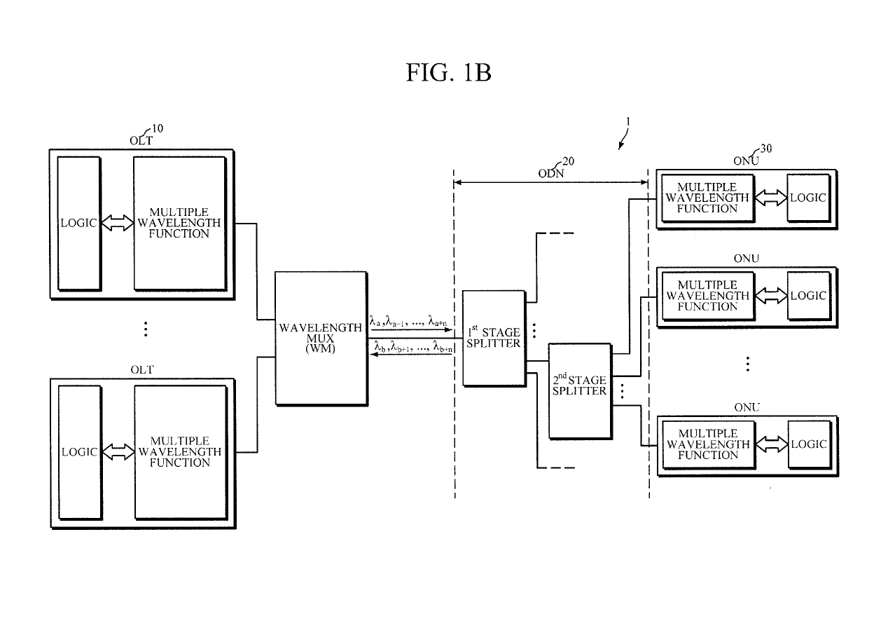

In the MW PON system as illustrated in FIGS. 1 (A) and (B), a process of setting a link between one or more OLTs 10 and a plurality of ONUs 30 so that data may be transmitted and received between each of the OLTs and each of the ONUs 30. The link setting, which may be performed by using a PLOAM or OMCI channel, may include initializing a wavelength to be used by the ONU 30, allocating the wavelength to be used by the ONU 30 to the OLT 10, and the like.

In the MW PON system 1 that includes wavelength tunable device, the link setting process includes a wavelength tuning process (as well as time taken for the process) of the wavelength tunable device.

In the MW PON system 1 that includes a splitter-based ODN 20, the ONU 30 newly installed in the system is required to be allocated an initial wavelength to operate. The initial wavelength may include a downstream wavelength and an upstream wavelength. An allocation process of the initial wavelength, i.e., a wavelength initialization process, is essential for the activation of the ONU 30. In a case where a new ONU 30 is installed in the ODN 20, an initial downstream wavelength and upstream wavelength are required to be allocated automatically and at regular intervals between the OLT 10 and the new ONU 30. The wavelength allocation process may be performed as a part of the activation process of the new ONU 30.

In order for the new ONU 30 to have a proper communication with the OLT 10, a downstream wavelength and an upstream wavelength of the new ONU 30 are required to be allocated rapidly, and wavelength tuning may be required during an activation process.

In the MW PON system 1 that includes the ODN 20 based on an arrayed waveguide gating (AWG), only one wavelength may pass the ODN 20 for communications from the OLT 10 to ONU 30 or from the ONU 30 to the OLT 10. In this case, wavelength allocation may be performed during a physical installation process.

In the MW PON system 1, in a case where there is a heavy or light traffic while some wavelengths are in an idle state and others are under a heavy load, changing a wavelength allocated to the ONU 30 may be one example of load balancing, in which wavelengths of all or some of the ONUs 30 that are allocated wavelengths under load are changed to wavelengths in an idle state.

As describe above, traffic may be balanced among available wavelengths, and PON operations may be maintained in a stable state. Alternatively, in the MW PON system 1, if there is a light traffic while most of the wavelengths are being used, the number of wavelengths that are being used may be reduced to efficiently manage the MW PON system 1. In this case, by turning off a specific port of the OLT 10, and by changing a wavelength of the ONU 30 to a subset of available wavelengths, power of the OLT 10 may be saved.

In the MW PON system 1, a link setting process or a link resetting process may include a wavelength tuning process, in which a wavelength of the OLT 10 or the ONU 30 is changed to a newly allocated wavelength channel. Wavelength tuning includes changing an operating wavelength channel allocated to the ONU 30 in a link setting process, i.e., a wavelength channel that is previously operated, to a newly allocated wavelength channel. To this end, one or more of wavelength tunable device may be provided in the ONU 30 and/or the OLT 10 of the MW PON system 10.

In the wavelength tuning process, a wavelength channel tuning time may vary depending on the types or characteristics of wavelength tunable device, or methods of controlling the devices. Accordingly, in a process of setting a link between the OLT 10 and the ONU 30, it is required to consider a wavelength channel tuning time of wavelength tunable device included in the MW PON system 1.

That is, as for wavelength tunable device to be used in the MW PON system 1 where wavelength is constantly changed by dynamic wavelength allocation and the like, a wavelength channel tuning time is an important performance parameter, and the wavelength channel tuning time may be separated into a plurality of classes based on a wavelength tuning speed or a wavelength chancel tuning time. As a wavelength channel tuning time may vary depending on methods for measuring the time, a uniform method for measuring a wavelength channel tuning time of wavelength tunable device is required, along with an apparatus for implementing the method. Further, a wavelength channel tuning time of wavelength tunable device should satisfy wavelength time changing requirements by the MW PON system 1 in which wavelength tunable device are to be used.

In the wavelength channel tuning process, a tuning time is required to be clarified. Thus, a method of defining a wavelength channel tuning time will be described below.

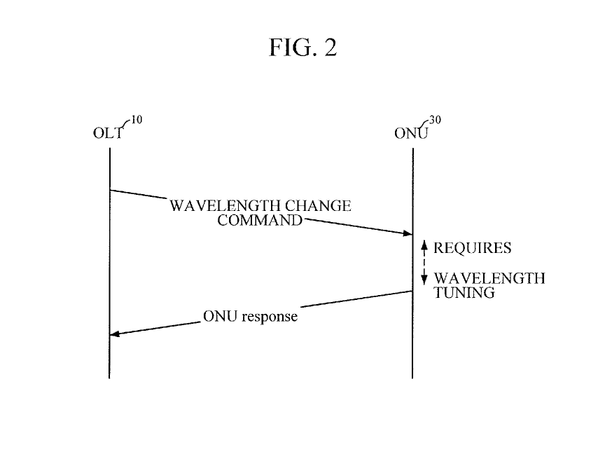

FIG. 2 is a flowchart to explain a wavelength channel tuning time in a wavelength channel tuning process. Once a command to change a wavelength channel is transmitted from the OLT 10 to the ONU 30, the ONU 30 performs a wavelength channel tuning process, and a process result is transmitted to the OLT 10.

In the present disclosure, the ONU to be described below refers to a wavelength is tunable ONU that includes one or more wavelength tunable device, and a wavelength tunable ONU that includes a wavelength tunable transmitter and a wavelength tunable optical receiver will be taken as an example in the description.

Wavelength channel tuning of the ONU 30 is performed by the following processes.

Process 1: receiving a wavelength channel change command from the OLT 10.

Process 2: turning off a wavelength tunable transmitter.

Process 3: leaving a previously used operating wavelength and arriving at a newly allocated wavelength channel to change an operating wavelength of a new wavelength channel.

Process 4: settling in a newly allocated wavelength channel and using it as a new operating wavelength.

Process 5: re-establishing a downstream framing from the OLT 10.

Process 6: turning on a wavelength tunable transmitter and starting communications with the OLT 10.

Process 7: performing a precise tuning (or recalibration).

A process of moving an operating wavelength in processes 3 and 4 is for both the wavelength tunable transmitter and the wavelength tunable receiver, and it should be noted that a wavelength tuning time of the wavelength tunable transmitter and the wavelength tunable receiver may be different.

Further, in a case where wavelength tunable device use an identical mechanism (thermal mechanism, mechanical mechanism, current injection mechanism, etc.), a time taken in process 3 has an identical value. The time is called a transition time, which is derived from a tuning distance and a tuning speed.

A time taken in process 4 is a time taken for a wavelength tunable device to stably tune an operating wavelength to a newly allocated wavelength channel and to be stabilized therein, which may be called a convergence time. The time varies depending on control methods, as well as a wavelength tunable mechanism of a tunable device, and may have different values.

Although embodiment of an optical element depends on vendors, standard specifications should be clear enough to guide which tunable device belongs to which tuning class, and thus “a tuning time” is required to be called “a wavelength channel tuning time” more specifically.

In the present disclosure, process 1 to process 4 of measuring a time by a wavelength tunable device, and a measuring system (setup) will be described. Process 2 takes time of several to scores of ns, which is negligible when compared to a time taken in process 3 and process 4, such that the time taken in process 2 will be excluded from a wavelength tuning time.

That is, in the present disclosure, a wavelength channel tuning time refers to “a maximum allowed time, which is duration from when a tunable device receives an operating wavelength channel change command to when the tunable device is tuned from the operating wavelength channel to a newly allocated wavelength channel to stably maintain the operating wavelength within the wavelength channel”.

In a case where a tunable device is a tunable optical transmitter, a wavelength channel tuning time refers to “a maximum allowed time, which is duration from when the tunable device receives an operating wavelength channel change command signal to when the tunable device is tuned from the operating wavelength channel to a newly allocated wavelength channel to stably maintain an optical power output within the newly allocated wavelength channel (maximum allowed time taken from an optical power of the tunable laser disappear in the original wavelength channel (after a wavelength change signal) to a time when the tunable device tunes to a desired wavelength channel and stably remains within the desired wavelength channel).

According to the definition of the wavelength channel tuning time described above, the following equation may be induced.

Wavelength channel tuning time=indefinite time+(N×CS−2×MSE)+finishing section time, in which the indefinite time includes some latency due to the processing time, a time of (N×CS−2×MSE) will be a physically fixed value according to a tuning mechanism, and a finishing section time depends on a control circuit of a tunable device.

Common characteristics of the NG-PON2 system is a function of tuning a transmitter, or a receiver, or both. In a downstream direction from the OLT to the ONU, the tunable ONU receiver is required to select a proper channel. In an upstream direction from the ONU to the OLT, the ONU transmitter is tuned so that a necessary channel may be output. Channel selection capability of an OLT receiver may vary depending on the NG-PON2 system, which may be defined for a central frequency, central frequency distribution, channel spacing, tuning characteristics, and a tuning time of a transmitter and a receiver may be separated into a plurality of classes that have different applications for every case.

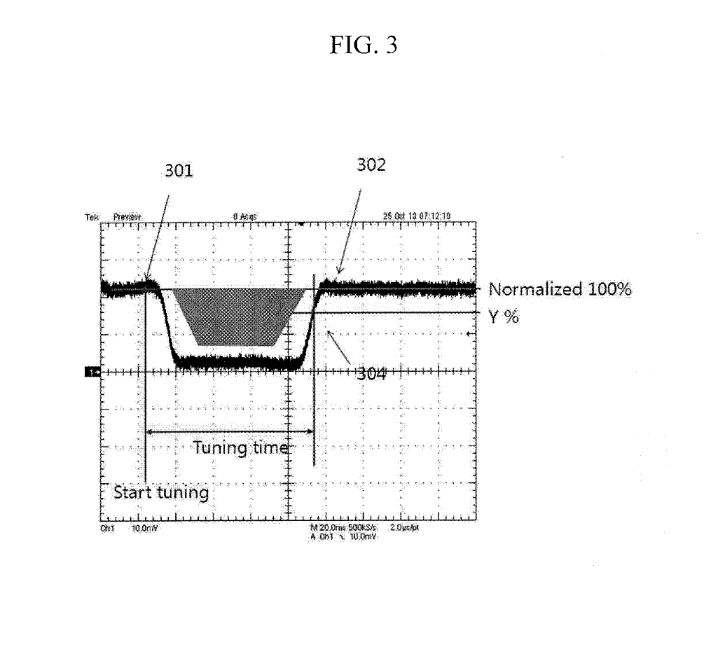

FIG. 3 is a diagram illustrating a tuning mask is applied to an optical intensity changed according to a change in a measured wavelength, according to an exemplary embodiment.

Referring to FIG. 3, a wavelength channel tuning time may be measured by applying a tuning mask to a measured optical intensity change. In the tuning mask, if a maximum value maintained before wavelength tuning is defined as level 1 301 prior to wavelength tuning, and a maximum value maintained after wavelength tuning is defined as level 2 302, a wavelength channel tuning time may be a time difference between a point in time of a wavelength tunable command given to a tunable device and a level 304 corresponding to Y % of the level 1 after wavelength tuning.

The level 1 may be detected by analysis using horizontal histogram.

Y represents values from 0 to 100, which may vary depending on a transmission is bandwidth of a set of optical filters and a transmission spectrum.

That is, once a user inputs information on a system where a tunable device to be measured is used, a Y value is automatically calculated, a tuning time may be calculated automatically based on a measured value, and a margin of tolerance may be automatically calculated based on a measured value in a case where a tunable device is used as a specific wavelength tuning time class.

In the present disclosure, measuring a tuning time by the wavelength tuning mask is merely an illustrative example, and setting a finishing point to be a specific number of percentage of a rising edge depends on WDM wavelength specifications such as a spectral excursion of a system where a tunable device is to be used.

Hereinafter will be described how to specifically define the above-described tuning time. In an exemplary embodiment, a wavelength channel tuning time is between N×CS+2×MSE and N×CS−2×MSE, in which N represents a channel count, CS represents channel spacing in GHz, an MSE refers to a Maximum Spectra Excursion in GHz. This range may not be represented by a simple equation such as N×CS+2×MSE or N×CS−2×MSE. The wavelength channel tuning time refers to a maximum allowed time for a tuning a tunable device to perform tuning. The tuning time is a time required for the tunable device to tune from a specific wavelength to another wavelength in a spectral excursion, which is tuned to the maximum, in a specific ambient temperature. The tuning time may vary depending on ranging, wavelength changing, wavelength fine-tuning. The tuning time of ONU may be measured by using the following procedures and a test setup. The purpose of the test setup is to measure a tuning time without ambiguity, in which the measurement is performed for a short wavelength to a long wavelength.

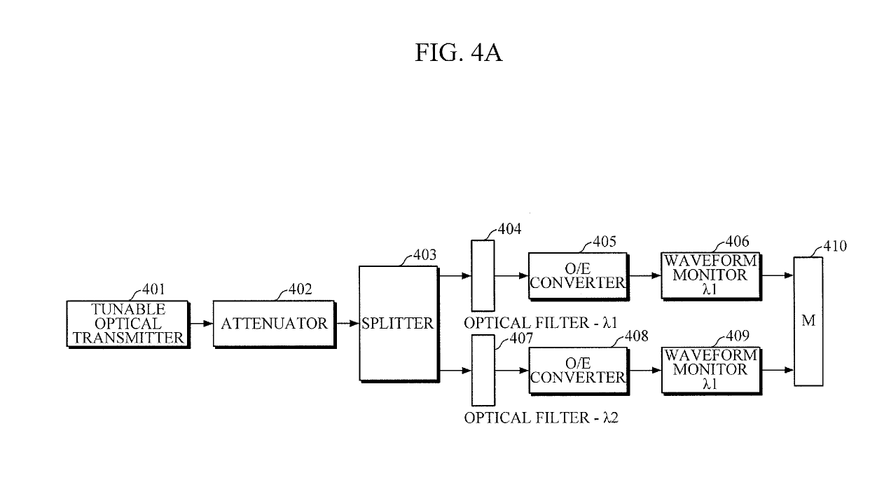

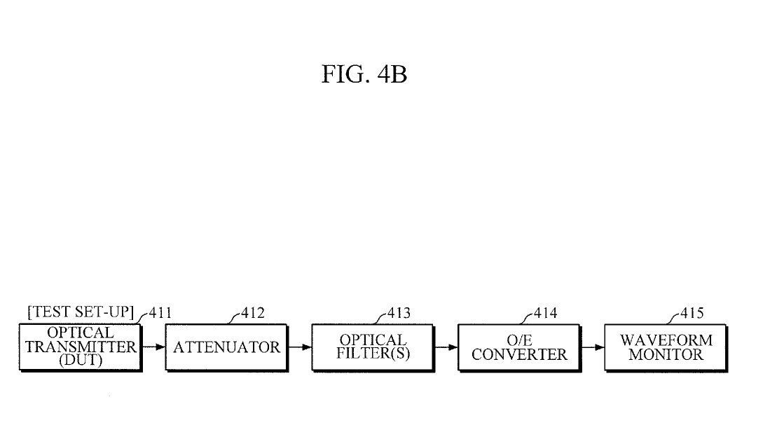

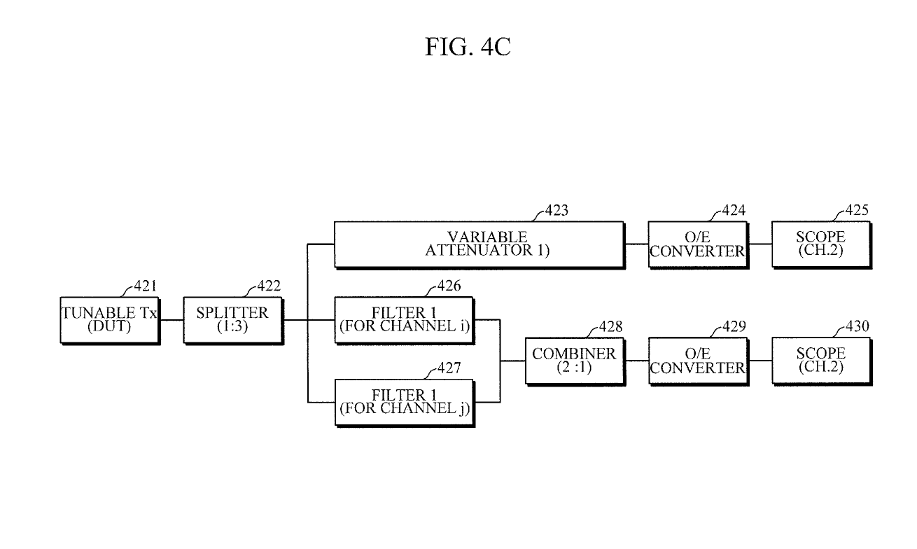

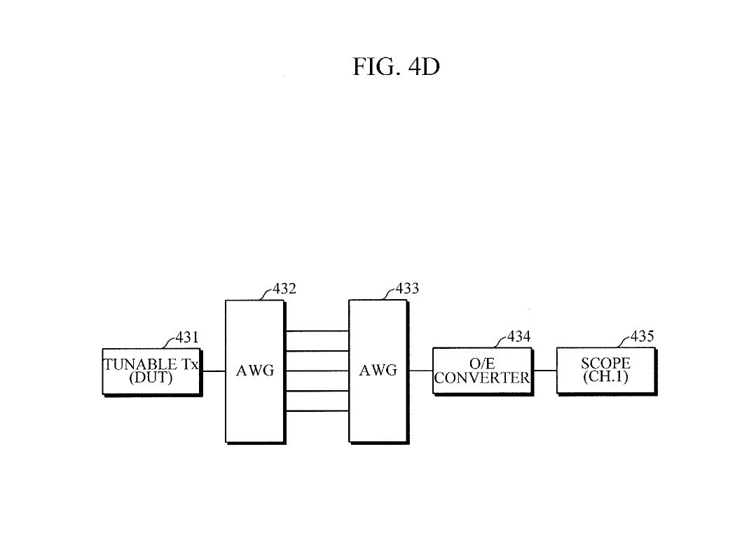

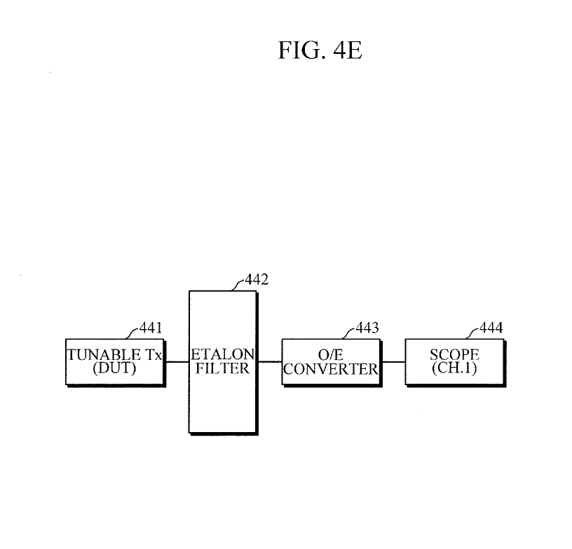

FIGS. 4 (A) to 4(E) are diagrams illustrating an example of a test setup used for measuring a wavelength channel tuning time of a wavelength tunable optical transceiver according to an exemplary embodiment.

A reference optical filter to be described below in the present disclosure should reflect a wavelength channel of a system where a tunable device is to be used.

FIG. 4 (A) illustrates a case that uses two optical filters 404 and 407 as a reference filter. A central wavelength of the reference optical filters 404 and 407 may be changed, and should be set according to conditions under which measurement is to be performed. That is, if a central filter of one of the two reference optical filters is tuned to a starting wavelength channel, a central filter of the other reference optical filter is required to be tuned to a target channel wavelength. Photoelectric efficiency, i.e., responsivity, of the O/E converters 405 and 408 should be the same. If the O/E converters 405 and 408 have different photoelectric efficiencies, a measure resulting value should be calibrated to determine a wavelength tuning time.

In this case, upon combining power of two wavelengths in 410, a wavelength channel tuning time is measured, in which an attenuator 402 is used to prevent overload of the O/E converters 405 and 408 and may be disposed on a specific optical path between a DUT 401 and O/E converters 405 and 408.

FIG. 4 (B) is a test setup that may be used to measure a wavelength tuning time of a tunable optical transmitter by using one or more optical filters 413 as a reference filter. In a case where there is one reference optical filter, a central filter of the reference optical filter is required to be tuned to a target wavelength channel.

FIG. 4 (C) is a test setup that uses two optical filters 1 and 2 426 and 427 as reference optical filter, in which a central wavelength of the reference filter may be changed, and should be set according to conditions under which measurement is to be performed. That is, if a central wavelength of two reference optical filters is tuned to a starting wavelength channel, a central wavelength of the other reference optical filter should be tuned to a target channel wavelength. FIG. 4 (C) illustrates a structure in which a 1×3 optical splitter 422 is used to check whether an optical output is constant when an operating wavelength of a wavelength tunable optical transmitter to be measured is changed, in which a tunable attenuator 423 is used to prevent overload of the O/E converter 424, and may be omitted.

FIG. 4 (D) is a test setup that uses, as a reference optical filter, a structure where two tiers 423 and 433 of AWG are connected, in which AWG may set a 1:N connection, such that only the desired channels may be selectively measured. That is, after forming various AWG connections, a tuning time of the tunable optical transmitter 431 may be measured.

FIG. 4 (E) is a test setup that uses an etalon filter 442 as a reference optical filter.

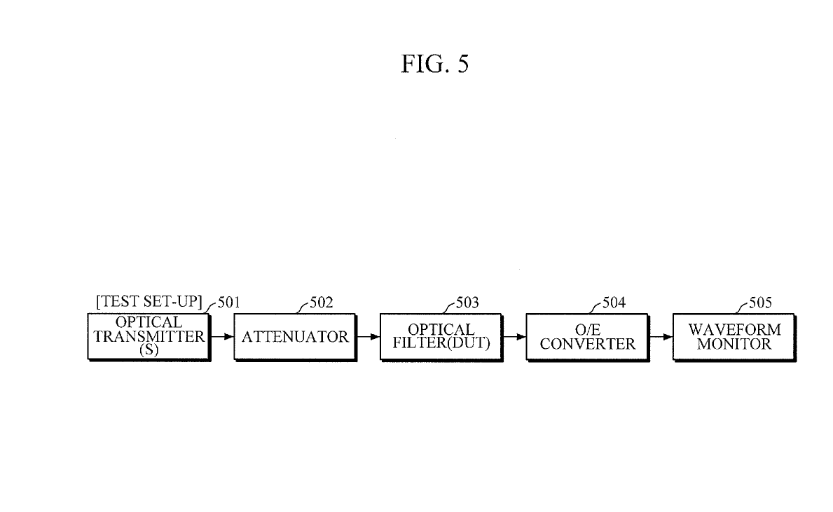

FIG. 5 is a block diagram illustrating an example of a test setup used for measuring a wavelength channel tuning time of a wavelength tunable optical filter according to an exemplary embodiment. In this case, one or more optical transmitters may be used as a reference optical transmitter. If only one optical transmitter is used as a reference optical transmitter, an output wavelength of a reference optical transmitter should be tuned to a target operating wavelength of a wavelength tunable optical filter to be measured. If two optical transmitters are used as a reference optical transmitter, an output wavelength of one of the two reference optical transmitters is required to be tuned to a starting wavelength channel of DUT, and an output wavelength of the other reference optical transmitter is required to be tuned to a target wavelength channel of DUT. If a wavelength tunable optical transmitter is used as a reference optical transmitter, a wavelength tuning time should be shorter than DUT.

Thus, DUT illustrated in FIGS. 4 and 5 may include a tunable optical transmitter, a tunable optical filter, or a tunable receiver that includes a tunable optical filter. FIGS. 4 and 5 are merely illustrative examples of various optical elements for measuring a tuning time, and if a method of measuring a tuning time in the present disclosure is used, separating the measured tuning time of various optical elements into classes is considered within a scope of the present disclosure.

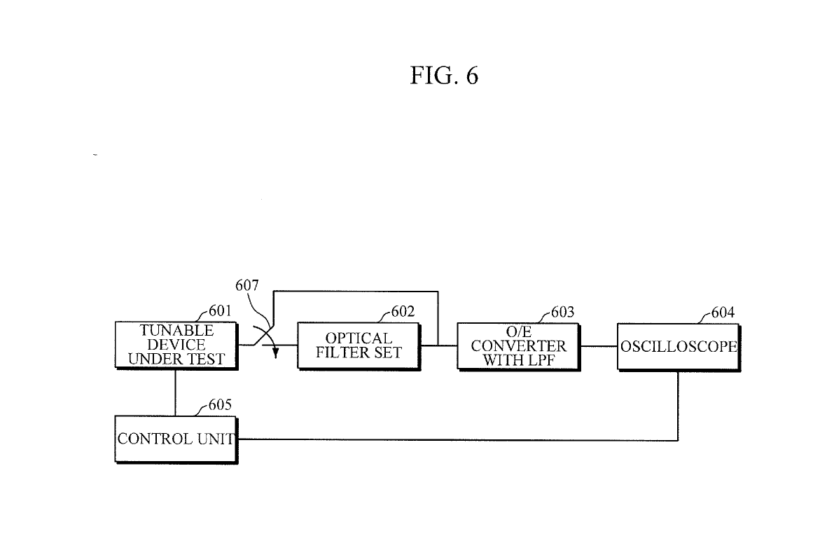

FIG. 6 is a block diagram illustrating an example of a system for measuring a wavelength channel tuning time of a tunable device according to another exemplary embodiment.

The system for measuring a wavelength channel tuning time of a tunable device may have a structure where separate constituent elements may be connected in various networks, or may form a single device.

Referring to FIG. 6, the system for measuring a wavelength channel tuning time of a tunable device includes a reference optical filter set 602, an optical electric converter 603, an waveform monitor 604, and a controller 605.

The reference optical filter set 602 includes a combination of reconfigurable optical filters. A central wavelength of each of the optical filters included in the optical filter set 602 is tunable and may be set according to conditions under which measurement is to be performed.

The reference optical filter set 602 has two or more pass bands within a wavelength tuning range of an optical element 601 to be measured. Transmission loss of each of the optical filters included in the optical filter set 602 is required to be normalized in a desired wavelength band. Characteristics of channel spacing and spectra excursion in a specific network should be reflected in the optical filter set 602.

The optical electric converter 603 is positioned between the reference optical filter set 602 and the waveform monitor 604, and converts optical intensity output from the reference optical filter set 602 into electric intensity that may be observed by the waveform monitor 604.

The optical electric converter 603 may include one or more low-pass filters, and a bandwidth of the low-pass filter may have values between 10×(1/Tₜᵣ) Hz, in which Tₜᵣ represents a time when an output wavelength of a tunable device to be measured moves.

Further, maximum allowed optical intensity in the optical electric converter 603 may be ten times higher or more than optical intensity output from a tunable device to be measured. Although not illustrated in FIG. 6, optical intensity may be adjusted before light output from the tunable device 601 is applied to the optical electric converter 603 by using various types of attenuators.

The waveform monitor 604 may display optical intensity converted into an electric signal output from the optical electric converter 603. The waveform monitor 604 may have a function of an oscilloscope, and stores signals output from the optical electric converter 603.

Further, the waveform monitor 604 may store signals transmitted from the controller 605 to be described later, and display the signals on a waveform monitor. The waveform monitor 604 may display two or more input signals, and monitor changes in output wave forms according to elapsed time.

For example, the waveform monitor 604 may display both signals transmitted from the controller 605 and signals transmitted from the optical electric converter 603 at the same time, and may monitor waveform changes of both of the signals according to elapsed time. A signal transmitted from the controller 605 may be a wavelength change control signal to change wavelengths of the tunable device 601.

The controller 605 generates a wavelength change command to change wavelengths of the tunable device 601. The wavelength change command may be a control message to change a wavelength to a target wavelength, or may be a direct current/voltage.

Further, the controller 605 may calculate a wavelength channel tuning time of the tunable device 601 based on a wavelength change control signal stored and monitored by the waveform monitor 604 and a wave form of a signal output from the optical electric converter 603.

The system for measuring a wavelength channel tuning time operates the following processes to measure a wavelength channel tuning time of the tunable device 601.

First, the controller 605 generates a wavelength change control command to change a wavelength of the tunable device 601. Then, the generated wavelength change command is applied to the tunable device 601 that is connected in a network, and the tunable device 601 starts to change a wavelength channel to a target wavelength based on the transmitted wavelength change command.

An optical signal output from the tunable device 601 is applied to the optical filter set 602, and the optical filter set 602 passes only a wavelength of a specific band in an applied output optical signal. The applied output optical signal refers to a signal with a wavelength channel changed by the tunable device 601 to a target wavelength, and the optical filter set 602 is set to pass only the target wavelength channel band.

An optical signal of the target wavelength channel that has passed through the optical filter set 602 is applied to the optical electric converter 603, which converts an input optical signal of the target wavelength channel into an electric signal.

An optical signal of the target wavelength channel converted into an electric signal by the optical electric converter 603 is transmitted to the waveform monitor 604, which stores and displays an input electric signal of the target wavelength channel.

A wavelength change command generated by the controller 605 is transmitted to the waveform monitor 604 through a network, which stores and displays the wavelength change command along with an electric signal of the target wavelength channel described above.

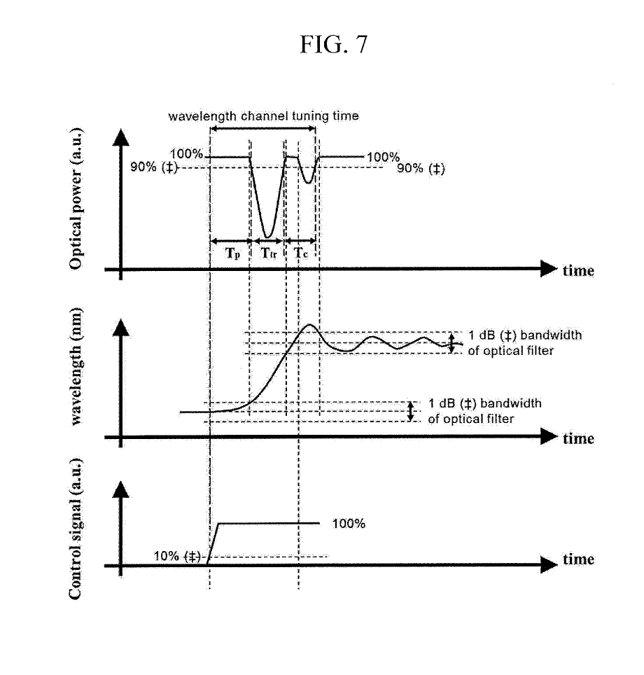

FIG. 7 is a diagram illustrating a measuring result of optical intensity changed according to wavelength changes according to an exemplary embodiment. FIG. 7 (A) illustrates displaying on the waveform monitor 604 a result of an optical intensity change according to a wavelength change. FIG. 7 (B) illustrates displaying on the waveform monitor 604 a wavelength change command.

Referring to FIG. 7, in a method of calculating a wavelength channel tuning time by the controller 605, the controller 605 determines a point in time, which is Z % (e.g., 10%) of a maximum output, as a starting point, in which the determined starting point is considered a point in time when a wavelength change command is applied to the tunable device 601.

Further, after waiting for an optical intensity change according to a wavelength change to converge for a predetermined time or more, the controller 605 determines a point in time, which is Y % (e.g., 90%) of a maximum optical intensity after the convergence, as a finishing point to calculate a wavelength channel tuning time. The wavelength channel tuning time may be calculated by using a difference between the determined starting point and finishing point.

The wavelength channel tuning time may be represented by a time indicator that may be measured by the waveform monitor 604, as in the following Equation I.

T_{P}+T_{CR}+T_{C}, [Equation 1]

in which Tₚ is a latency time or a processing time taken for an apparatus and method for changing an output wavelength of a tunable device, and refers to a period from a time when a wavelength change command is given to a tunable device (a point in time that is Z % of a maximum output of a wavelength change command) to a time when optical intensity of an original wavelength before wavelength changing is changed by Y %.

T_{c} is a time taken for an optical intensity change, which may be measured in a WDM channel, to be stabilized within Y % of a final optical intensity, and when an optical intensity change converges for more than a predetermined time after a wavelength is changed to a target wavelength, T_{c} is a time from a starting point of Y % (e.g., 90%) of a maximum optical intensity to a finishing point of Y % of a maximum optical intensity.

Tₜᵣ is a time when an output wavelength of a tunable device moves, and a time between Tₚ and T_{c}.

The system for measuring a wavelength channel tuning time of a tunable device according to an exemplary embodiment may include two input ports (a first input port and a second input port) that are connected to the tunable device 601 to be measured.

The first input port directly connects the tunable device 601 and the optical filter set 602, and the second input port directly connects the tunable device 601 and the optical electric converter 603.

The system for measuring a wavelength channel tuning time of a tunable device according to an exemplary embodiment may further include a switch 607 on a front end of the optical filter set 602 that may be electrically or electronically turned on or off. According to an operation of the switch 607, the tunable device 601, the optical filter set 602, and the optical electric converter 603 may be selectively connected. For example, when the switch 607 is turned on, the tunable device 601 may be directly connected to the optical filter set 602, when the switch 607 is turned off, the tunable device 601 may be directly connected to the optical electric converter 603.

Here, the tunable device 601 is selectively connected to the optical filter set 602 or the optical electric converter 603 to secure measurement reliability of a wavelength channel tuning time.

For example, in order to measure with reliability a wavelength channel tuning time, characteristics of the tunable device 601 to be measured are required to be constantly maintained, or performance required for the optical electric converter 603 is required to be constantly provided.

As described above, in order to maintain characteristics of the tunable device 601, or in order to secure performance of the optical electric converter 603, an initial setting for measuring a wavelength channel tuning time is required.

An initial setting process according to an exemplary embodiment is as follows.

First, the tunable device 601 is connected to the second input port or the switch 607 is operated to be directly connected to the optical electric converter 603.

Then, the controller 605 generates a wavelength change command to change a wavelength of the tunable device 601. Subsequently, the generated wavelength change command is applied to the tunable device 601 that is connected through a network, and the tunable device 601 starts to change a wavelength channel to a target wavelength based on the transmitted wavelength change command.

An optical signal with a wavelength channel changed to a target channel is applied to the optical electric converter 603 without passing through the optical filter set 602, and the applied optical signal is converted into an electric signal to be output to the waveform monitor 604.

If characteristics of the tunable device 601 is constantly maintained, and performance required for the optical electric converter 603 is constantly provided, a wave form output to the waveform monitor 604 will converge after a lapse of a predetermined time.

If a wave form of a signal that are output to the waveform monitor 604 do not converge even after a lapse of a predetermined time, the tunable device 601 or the optical electric converter 603 is considered not to be in a normal condition to operate.

Once a wave form of an output signal converge after a lapse of a predetermined time according to an initial setting process, a wavelength channel tuning time is measured according to the measurement process, and accordingly, reliability of the measurement may be secured.

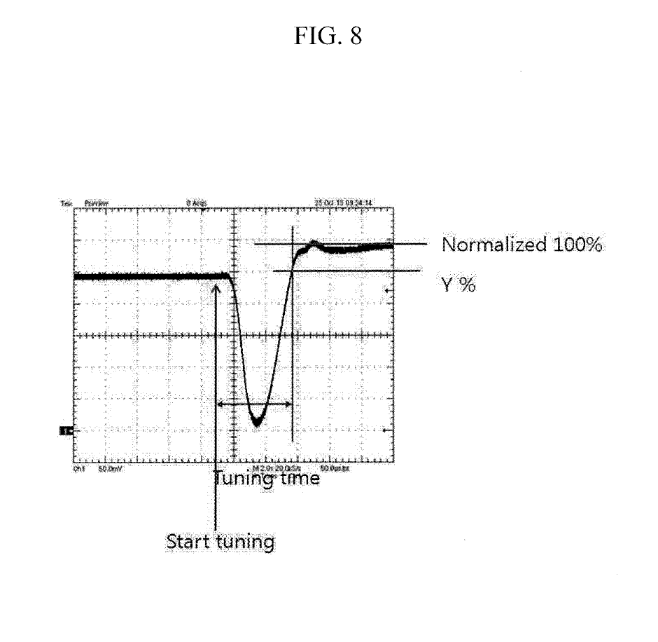

FIG. 8 is a diagram illustrating another measuring result of optical intensity changed according to wavelength changes according to an exemplary embodiment, and more specifically, through an examination using a TEC-controlled DFB-laser, FIG. 8 illustrates an example of measuring a tuning time of a waveform of the laser according to an exemplary embodiment.

FIG. 8 is a wavelength tuning diagram in a case where level 1 before wavelength tuning and level 1 after wavelength tuning are not identical to each other. In an optical tunable device, optical output intensity or insertion loss may be different, in which case, level 1 before wavelength tuning may be different from level 1 after wavelength tuning. In this case, normalization of level 1 before and after wavelength tuning may be performed to measure a wavelength channel tuning time. However, without normalization, a difference between a starting point and a finishing point may be calculated as a tuning time, in which a point in time where a wavelength command is applied to a tunable device may be set as a starting point, and a point in time where the tunable device is measured by the waveform monitor by using a setup for measuring a tunable device, and the value may be set as a Y value of a final target value.

A Y value is a value that may vary depending on a form of transmission bandwidth and transmission spectrum. That is, upon determining spectral excursion and the like of a WDM channel of a system where a tunable device is used, an insertion loss value of an optical filter at a point of spectral excursion may be measured in advance, so that the value may be used as a Y value.

In a case where an optical filter set used in the apparatus for measuring a wavelength channel tuning time is configured to transmit an initial wavelength and a final wavelength of a tunable device, an optical intensity change due to wavelength change according to elapsed time is illustrated in FIG. 3 or FIG. 8.

While FIG. 3 illustrates normalization of a power change of a wavelength, FIG. 8 illustrates a case where normalization is not performed. The result in FIG. 8 may be obtained if there is a difference in insertion loss according to wavelengths of a tunable device, or if there is a change in output intensity according to wavelengths of a tunable device. More specifically, if temperature of a DFB laser is increased or decreased without using an auto power control (APC) function for a DFB laser to change a wavelength channel, such result may be obtained.

Tuning time measuring procedures are as follows.

First, a method for controlling a tunable device is determined.

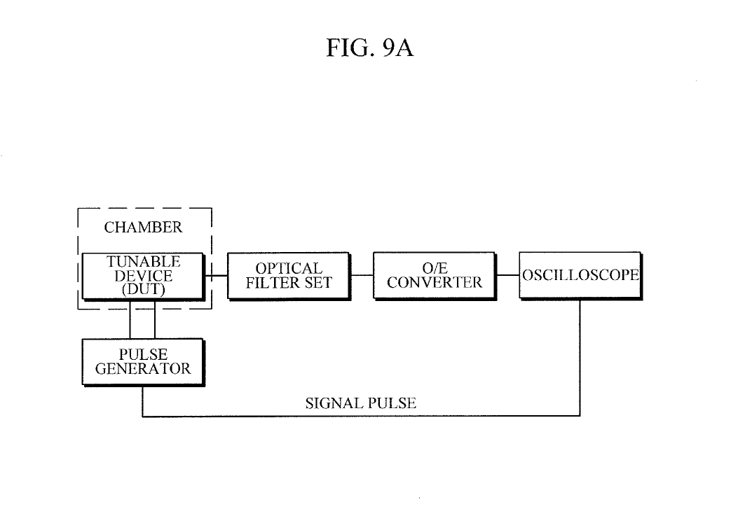

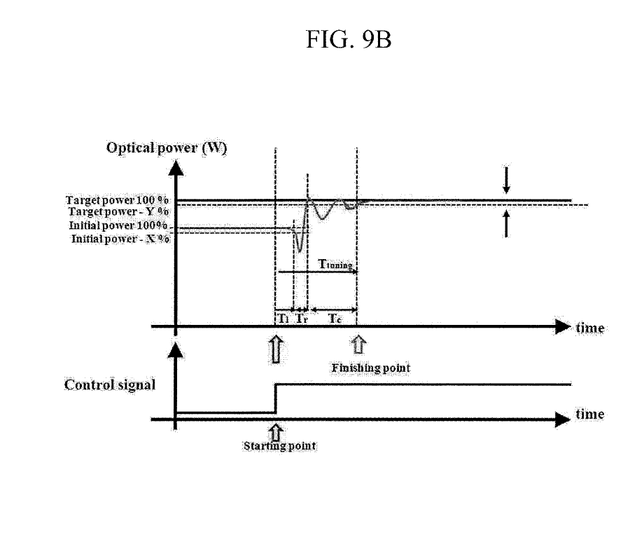

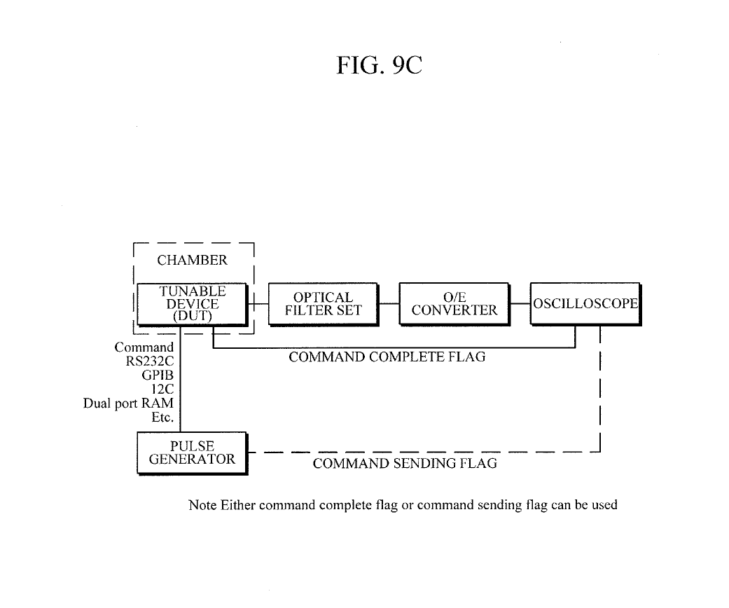

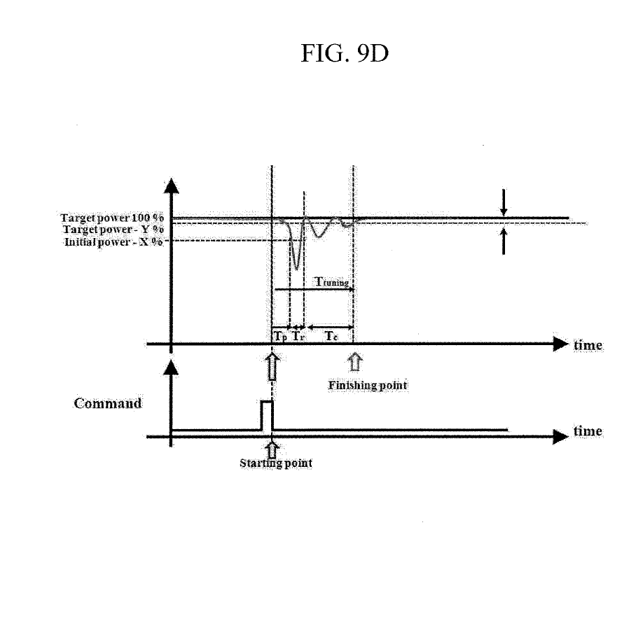

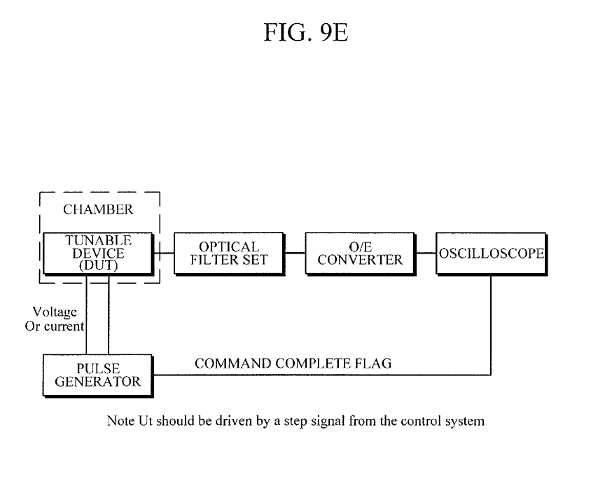

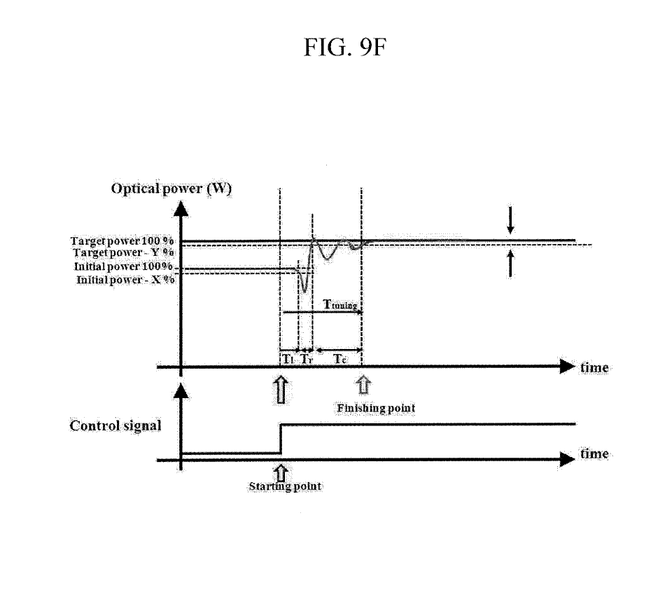

In a case where a control method of changing an output wavelength of a tunable device by using a pulse generator through direct current or direct voltage, a measuring setup illustrated in FIG. 9A is selected. FIG. 9B is a graph illustrating information for measuring a wavelength channel tuning time of a specific output wavelength from a starting point of a control signal in the measuring setup of FIG. 9A.

By turning on in advance devices of measuring setup, along with a tunable device, the devices may be preheat to be stabilized.

In a case where output optical intensity of a tunable device is too high, a variable optical attenuator may be positioned at a front end of an optical filter set or at a front end of an O/E converter, so that the O/E converter may not be overloaded.

An initial wavelength and a target wavelength, of which a tuning time is to be measured, are determined. By checking a transmission wavelength of an optical filter set of a measuring setup, it may be checked one more time whether the target wavelength is a transmittable wavelength.

After checking how much voltage or current is required to be applied to a tunable device to tune from an initial wavelength to a target wavelength, a pulse generator is set so that required voltage or current may be applied.

A pulse generator is operated to apply the set voltage or current to a tunable device.

Upon checking a wave-form change on the waveform monitor, a tuning time (Tt) is calculated. A Y value used in the calculation may vary depending on a WDM channel width of a system where a tunable device is to be used, or on a transmittance width, and a transmittance spectrum of an optical filter used in a measuring device. Further, a Y value may be set by a user to be automatically calculated by selecting specifications of a system where a tunable device is to be used.

If necessary, the above processes may be performed twice or more to obtain an average value.

A tuning class of a tunable device may be identified by using an average tuning time.

If necessary, a measured tuning time of a tunable device may be programmed to be displayed along with tuning time margin that may maintains a tuning time as a tuning class.

In a case where a control method of changing an output wavelength of a tunable device by using a command though RS232, GPIB, I2C, and the like, a measuring setup illustrated in 9C is selected. FIG. 9D is a graph illustrating information for measuring a wavelength channel tuning time of a specific output wavelength from a starting point of a control signal in a measuring setup in FIG. 9C.

Referring to FIGS. 9C and 9D, by turning on in advance devices of measuring setup, along with a tunable device, the devices may be preheat to be stabilized.

In a case where output optical intensity of a tunable device is too high, a variable optical attenuator may be positioned at a front end of an optical filter set or at a front end of an O/E converter, so that the O/E converter may not be overloaded.

An initial wavelength and a target wavelength, of which a tuning time is to be measured, are determined. By checking a transmittance wavelength of an optical filter set of a measuring setup, it may be checked one more time whether the target wavelength is a transmittable wavelength.

After checking a command to be given to a tunable device to move from an initial wavelength to a target wavelength, a command is transmitted to the tunable device.

Upon checking a wave-form change on the waveform monitor, a tuning time (Tt) is calculated. A processing time (Pt), which is included in the tuning time, may be calculated by using a command sending flag or a command completer flag. A Y value used in the calculation may vary depending on a WDM channel width of a system where a tunable device is to be used, or on a transmittance width, and a transmittance spectrum of an optical filter used in a measuring device. Further, a Y value may be set by a user to be automatically calculated by selecting specifications of a system where a tunable device is to be used.

If necessary, the above processes may be performed twice or more to obtain an average value.

A tuning class of a tunable device may be identified by using an average tuning time.

If necessary, a measured tuning time of a tunable device may be programmed to be displayed along with tuning time margin that may maintain the tuning time as a tuning class.

In a case where a control method of changing an output wavelength of a tunable device by using a step signal that may change voltage or current, a measuring setup illustrated in FIG. 9E is selected. FIG. 9F is a graph illustrating information for measuring a wavelength channel tuning time of a specific output wavelength from a starting point of a control signal in a measuring setup in FIG. 9E.

Referring to FIGS. 9E and 9F, by turning on in advance devices of measuring setup, along with a tunable device, the devices may be preheat to be stabilized.

In a case where output optical intensity of a tunable device is too high, a variable optical attenuator may be positioned at a front end of an optical filter set or at a front end of an O/E converter, so that the O/E converter may not be overloaded.

An initial wavelength and a target wavelength, of which a tuning time is to be measured, are determined. By checking a transmission wavelength of an optical filter set of a measuring setup, it may be checked one more time whether the target wavelength is a transmittable wavelength.

Upon checking a size of a signal to be transmitted to a tunable device to tune from an initial wavelength to a target wavelength, the signal is applied.

Upon checking a wave-form change on the waveform monitor, a tuning time (Tt) is calculated. A Y value used in the calculation may vary depending on a WDM channel width of a system where a tunable device is to be used, or on a transmittance width, and a transmittance spectrum of an optical filter used in a measuring device. Further, a Y value may be set by a user to be automatically calculated by selecting specifications of a system where a tunable device is to be used.

If necessary, the above processes may be performed twice or more to obtain an average value.

A tuning class of a tunable device may be identified by using an average tuning time.

If necessary, a measured tuning time of a tunable device may be programmed to be displayed along with tuning time margin that may maintain the tuning time as a tuning class.

Disclosed is a method for separating classes of a tunable device in an optical communication network, and an apparatus therefor. In a case where a tunable device included in an optical communication network requires a wavelength channel tuning, such as setting, changing, initializing, activating of wavelength channels, setting and changing of links, or combinations thereof, a wavelength channel tuning time of the tunable device is measured, and based on the measured tuning time, and by using a method and apparatus for separating classes of a tunable device, a timer setting of the optical communication network may be performed according to classes, thereby enabling efficient management of the optical network.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for separating classes of an optical tunable device that includes a tunable transmitter, the apparatus comprising:
an optical filter set configured to convert a transmission wavelength change of the optical tunable device into an optical output intensity change;
at least one or more optical electric converters configured to convert the optical output intensity change by the optical filter set into an electric signal; and
a waveform monitor configured to monitor a waveform of the signal converted into the electric signal by the at least one or more optical electric converters,
wherein the apparatus for separating classes of the optical tunable device determines classes of the optical tunable device based on a wavelength channel tuning time of the optical tunable device.

2. The apparatus of claim 1, further comprising a controller configured to transmit a wavelength channel change command to the optical tunable device.

3. The apparatus of claim 2, wherein the controller is a pulse generator that applies a direct current or a direct voltage, or a device that applies a step signal to apply a direct current or a direct voltage, so as to change an output wavelength of the optical tunable device.

4. The apparatus of claim 2, wherein the wavelength channel tuning time is duration from when a wavelength change command is given by the controller to when a waveform of a signal displayed on the waveform monitor begins to be stabilized in a target wavelength-division multiplexing (WDM) channel.

5. The apparatus of claim 4, wherein the wavelength channel tuning time is (Tₚ or Tₗ)+Tₜᵣ+T_{c},
wherein the (Tₚ or Tₗ) is a processing time or latency time for an output wavelength of the optical tunable device to be changed, T_{c} is a time for a measurable optical intensity change to begin to be stabilized in the target WDM channel, and Tₜᵣ is a time between Tₚ and T_{c}.

6. The apparatus of claim 1, wherein the optical tunable device has a function of constant temperature.

7. The apparatus of claim 1, wherein the optical tunable device is included in an optical line terminal (our) or in an optical network unit (ONU) of a passive optical communication network system.

8. The apparatus of claim 1, wherein the electric signal is a value for a change of power before and after a wavelength channel.

9. An apparatus for separating classes of an optical tunable device that includes a tunable receiver, the apparatus comprising:
one or more reference transmitters configured to transmit an optical signal of a specific wavelength to the optical tunable device;
at least one or more optical electric converters configured to convert the optical signal transmitted by the one or more reference transmitters and received by the optical tunable device; and
a waveform monitor configured to monitor a waveform of the optical signal converted into the electric signal;
wherein classes of the optical tunable device are determined by comparing a result monitored by the waveform monitor to a predetermined wavelength tuning mask.

10. The apparatus of claim 9, further comprising a controller configured to transmit a wavelength channel change command to the optical tunable device.
